(19) United States
(12) Patent Application Publication
(10) Pub. No.: US 2003/0103764 A1
(43) Pub. Date: Jun. 5, 2003

(54) Stream generation apparatus and digest mark data generation apparatus

(76) Inventors: Eiji Ueda, Toyota-gun (JP); Hidenori Tatsumi, Higashihiroshima (JP)

Correspondence Address: WENDEROTH, LIND & PONACK, L.L.P., 2033 K STREET N. W., SUITE 800, WASHINGTON, DC, 20006-1021, US

(21) Appl. No.: 10/309,054

(22) Filed: Dec. 4, 2002

(30) Foreign Application Priority Data
Dec. 5, 2001 (JP) 2001-371255

(51) Int. Cl. H04N 5/783; H04N 5/781

(52) U.S. Cl. 386/69; 386/70; 386/95

(57) ABSTRACT

In a digest mark data generation apparatus, program data is recorded in a recording medium. Video data composing the program data has reference marks provided at predetermined time intervals. The digest mark data generation apparatus further includes an input section that generates, in response to a user's operation, timing designation data indicative of either a time of starting a program digest or a time of ending the program digest; and a mark data generating section that generates digest mark data by extracting a reference mark provided to the video data recorded on the recording medium in accordance with the timing designation data received from the input section. With this, it is possible to provide a digest mark data generation apparatus for generating digest mark data that allows a sharing of a program digest.

### BACKGROUND OF THE INVENTION

1. Field of the Invention

The present invention relates to stream generation apparatuses and digest mark data generation apparatuses. More specifically, the present invention relates to a stream generation apparatus for generating a stream representing a broadcast program, and a digest mark data generation apparatus for generating digest mark data required for playing a digest of the broadcast program out of the stream generated by the stream generation apparatus.

2. Description of the Background Art

In digital broadcasting, a broadcast station provides users with a broadcast program and also, in some cases, a digest of the broadcast program. In such cases, the broadcast station may prepare and provide a plurality of different digests to users in order to meet the users' varied preferences. Of these digests, each user selects a preferred one for viewing.

However, it is quite burdensome for the broadcast station to prepare and provide such a plurality of different digests. Moreover, since the broadcast station can provide only a limited number of different digests, the user cannot always obtain a digest best suited for his or her preference. To get around these problems, Japanese Patent No. 3176893 discloses the following digest generation apparatus. This digest generation apparatus is incorporated in a set-top box placed at a user's side for receiving video information (stream) representing a broadcast program from a broadcast station. The broadcast station transmits the video stream including indexes respectively provided to events occurring in the video stream. The digest generation apparatus previously stores numerical values respectively given to the indexes according to a user's preference as a rule file. By referring to these indexes included in the received video stream, the digest generation apparatus retrieves the corresponding numerical values from the rule file. Then, based on the retrieved numerical values and the indexes included in the received video stream, the digest generation apparatus generates numerical video information representing the contents of the video stream as a series of varied numerical values. Furthermore, the digest generation apparatus uses the varied numerical values of the generated numerical video information to extract images from the video program, thereby generating a digest of the broadcast program. With the aforementioned process, the digest generation apparatus can generate a digest more suited for the user's preference.

In general, some people have similar preferences among them. Therefore, it can be assumed that such people may desire to share the same digest generated according to their particular preferences. However, in the conventional digest generation apparatus, it is very difficult to generate such a sharable digest. Moreover, to generate a digest, the conventional digest generation apparatus always requires the above-mentioned rule file generated according the user's own preference that might be a matter of privacy, which should be protected from others.

### SUMMARY OF THE INVENTION

Therefore, an object of the present invention is to provide a digest mark data generation apparatus for generating digest mark data that facilitates a sharing of a digest of a broadcast program. Another object of the present invention is to provide a stream generation apparatus for generating a stream suited for generating the digest mark data.

The present invention has the following features to attain the objects above.

According to an aspect of the present invention, a stream generation apparatus includes: an encoding section operable to encode video data composing a program; a clock generating section operable to generate a clock signal at a first time interval; a timing signal generating section operable to generate a timing signal from the clock signal received from the clock generating section for output at a second time interval; and a reference mark adding section operable to add, in accordance with the timing signal generated by the timing signal generating section, reference mark data composed of a reference mark for use in generation of a program digest to the video data encoded by the encoding section.

According to another aspect of the present invention, a digest mark data generation apparatus includes a recording medium that records program data representing a predetermined program. Here, the program data includes video data and audio data. The video data is added with reference mark data composed of one or more reference marks added at a predetermined time interval. The digest mark data generation apparatus further includes an input section operable to generate, in response to an operation by a user, timing designation data indicative of a start or an end of a program digest; a mark data generating section operable to select, in accordance with timing designation data generated by the input section, a reference mark from the reference marks added to the video data recorded on the recording medium, and to generate digest mark data including the selected reference mark; and a recording section operable to record the digest mark data generated by the mark data generating section on the recording medium.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating the entire configuration of a broadcast system according to one embodiment of the present invention;

FIG. 2 is a block diagram illustrating a detailed structure of a broadcast station 1 illustrated in FIG. 1;

FIG. 3 is a schematic illustration showing reference mark data D_{RM1} and D_{RM2} provided by a reference mark adder 18 of FIG. 2;

FIG. 4 is a block diagram illustrating a detailed structure of each of reception apparatuses 2 of FIG. 1;

FIG. 5 is a schematic illustration showing program data DP and digest mark data D_{M} recoded on a recording medium 25;

FIG. 6 is a flowchart showing a procedure carried out by a mark data generator 211 of FIG. 4;

FIG. 7 is a schematic illustration showing one example of the digest mark data D_{M} generated through the procedure of FIG. 6;

FIG. 8 is a flowchart showing a procedure carried out by a digest reader 212 of FIG. 4;

FIG. 9 is a flowchart showing a detailed procedure of step S25 of FIG. 4;

FIG. 10 is a schematic illustration showing one example of a program digest to be played through the procedure of FIG. 8;

FIG. 11 is a schematic illustration for explaining how to share the digest mark data D_{M} between the reception apparatuses 2a and 2b of FIG. 1;

FIG. 12 is a block diagram illustrating a detailed structure of a reception apparatus 5 according to one modification example of the reception apparatus 2 of FIG. 4;

FIG. 13 is a flowchart showing a procedure carried out by a mark data generation apparatus 51 of FIG. 12;

FIG. 14 is a schematic illustration showing one example of digest mark data D_{M} generated through the procedure of FIG. 13;

FIG. 15 is a flowchart showing a procedure carried out by a digest reader 52 of FIG. 12;

FIG. 16 is a first-half of a flowchart of a detailed process of step S52 of FIG. 15;

FIG. 17 is a latter-half of the flow chart of the detailed process of step S52 of FIG. 15;

FIG. 18 is a schematic illustration for explaining processes of steps S67 through S69 of FIG. 16;

FIG. 19 is a schematic illustration for explaining processes of steps S610 through S612 of FIG. 16;

FIG. 20 is a schematic illustration for explaining processes of steps S613 through S619 of FIG. 16;

FIG. 21 is a schematic illustration for explaining processes of steps S620 through S625 of FIG. 17; and

FIG. 22 is a schematic illustration showing one example of a program digest to be played through the procedure of FIG. 15.

### DESCRIPTION OF THE PREFERRED EMBODIMENT

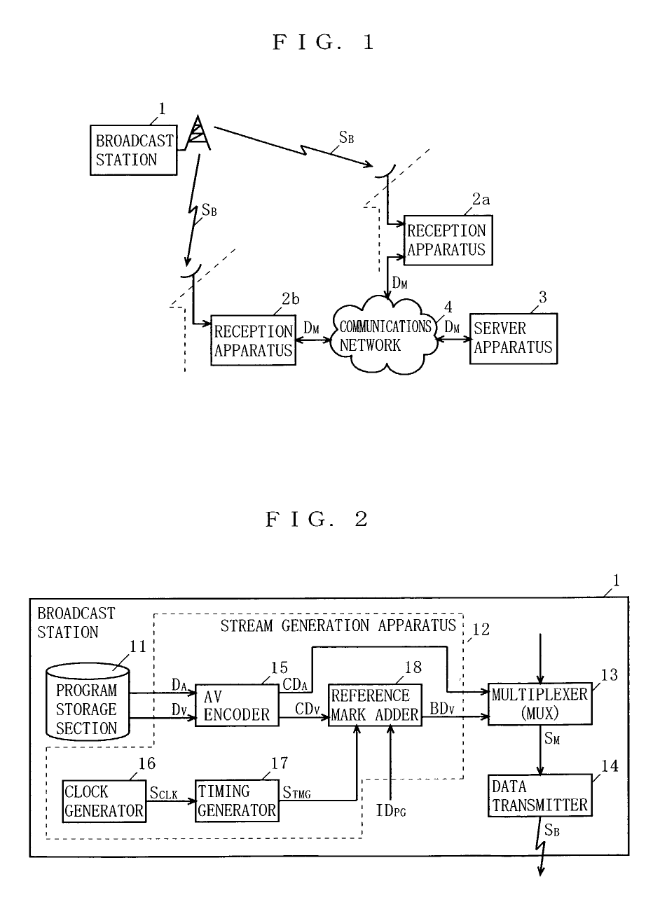

FIG. 1 is a schematic diagram illustrating the entire configuration of a broadcast system according to one embodiment of the present invention. In FIG. 1, the broadcast system includes a broadcast station 1, a plurality of reception apparatuses 2, at least one server apparatus 3, and a communications network 4 typified by the Internet. Note that FIG. 1 exemplarily illustrates two reception apparatuses 2a and 2b as the plurality of reception apparatuses 2. Each of these components is described in detail below.

FIG. 2 is a block diagram illustrating a detailed structure of the broadcast station 1 of FIG. 1. In FIG. 2, the broadcast station 1 includes a program storage section 11, a stream generation apparatus 12, a multiplexer (MUX) 13, and a data transmitter 14. The program storage section 11 stores at least one piece of program data D_{P} that composes a broadcast program. The program data D_{P} is a set of data composed of audio data D_{A} and video data D_{V}. The program storage section 11 sends the set of the audio data D_{A} and the video data D_{V} to the stream generation apparatus 12 at timing in accordance with a broadcasting schedule.

The stream generation apparatus 12 includes an AV encoder 15, a clock generator 16, a timing generator 17, and a reference mark adder 18. The AV encoder 15 is supplied with the set of the audio data D_{A} and the video data D_{V} from the program storage section 11. The AV encoder 15 encodes the received video data D_{V}, and then sends the encoded video data CD_{V} to the reference mark adder 18. The AV encoder 15 also encodes the received audio data D_{A}, and then sends the encoded audio'data D_{A} to the MUX 13. A typical encoding scheme performed by the AV encoder 15 is MPEG (Motion Picture Experts Group) 2 or MPEG 4.

The clock generator 16 generates a clock signal S_{CLK} at a predetermined time interval of T₁, and then outputs the generated clock signal S_{CLK} to the timing generator 17. The timing generator 17 generates a timing signal S_{TMG} based on the received clock signal S_{CLK}, and then outputs the generated timing signal S_{TMG} to the reference mark adder 18. Here, the timing signal S_{TMG} is typically a signal indicating a timing when the reference mark adder 18 adds reference marks RMᵢ, each reference mark indicative of either HIGH or LOW at a time interval of T₂ externally designated. In the present embodiment, assume herein for description convenience that the timing signal S_{TMG} indicates HIGH at the time interval T₂. Typically, the time interval T₂ is set to be longer than the time interval T₁, and is designated by the broadcast station side.

The reference mark adder 18 adds the reference marks RMᵢ (i=1, 2, 3, . . . ) to the received video data CD_{V} as reference mark data D_{RM} The reference marks RMᵢ are composed of numerical values incremented by a predetermined amount (1, for example) every time the received timing signal S_{TMG} becomes HIGH. Here, the reference mark data D_{RM} is added preferably to a field reserved for future use contained in the received video data CD_{V}. Furthermore, the reference mark adder 18 preferably further adds at least one identifier ID_{PG} for uniquely identifying a broadcast program (such identifier is hereinafter referred to as program identifier ID_{PG}) to the field having the reference mark data D_{RM} added thereto or to another field. In general, the broadcast station 1 retains a Program Map Table (PMT) associated with broadcast programs that contains program identifiers D_{PM}. From the PMT, the reference mark adder 18 retrieves the program identifier ID_{PG} to be added to the video data CD_{V}. The video data CD_{V} with the reference mark data D_{RM} added thereto is sent to the MUX 13 as embedded video data BD_{V}.

The MUX 13 multiplexes at least the received audio data CD_{A} with video data BD_{V} to generate a broadcast stream SM. Alternatively, the MUX 13 may further multiplex the broadcast stream S_{M} with other data (another program data D_{P}, for example) as required. The broadcast stream S_{M} is forwarded to the data transmitter 14. The data transmitter 14 performs a required process (adding error correction code and modulating, for example) onto the received stream S_{M} to generate a broadcast signal S_{B}. The broadcast signal S_{B} is emitted from an antenna.

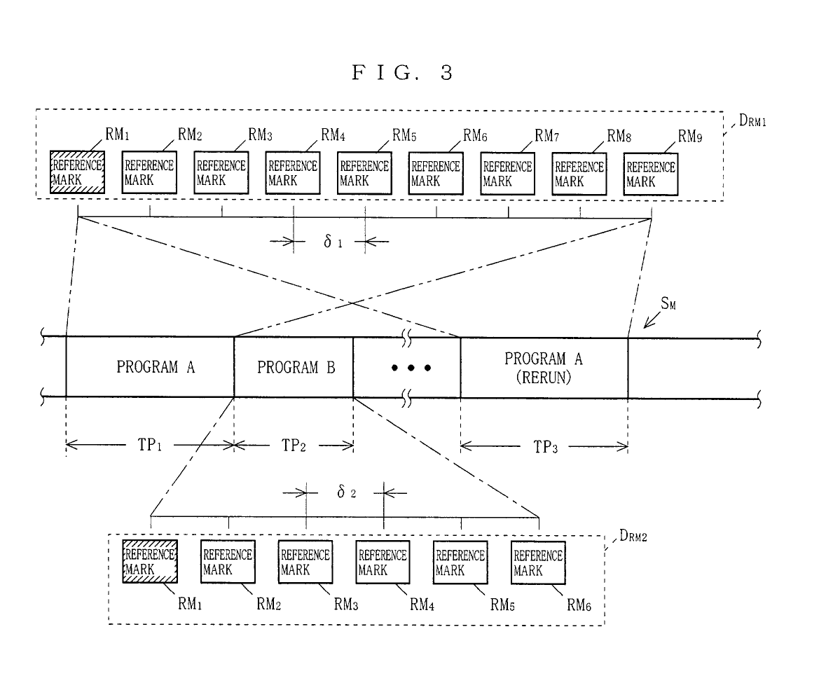

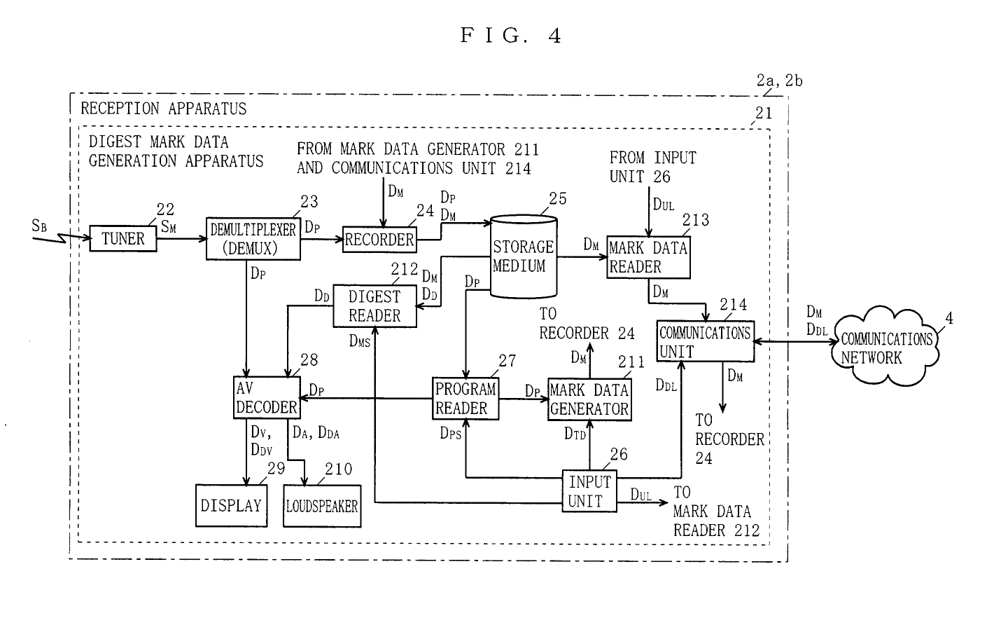

Here, as illustrated in FIG. 3, assume that the above-structured broadcast station 1 broadcasts program A during a time period TP₁, and then program B during the following time period TP₂. Furthermore, a time δ₁ is set as the time interval T₂ to program A, while a time δ₂ is set as the time interval T₂ to program B. Here, the times δ₁ and δ₂ may be either equal to or different from each other. Under these assumptions, during the time period TP₁, the broadcast stream S_{M} contains data resulted from multiplexing of the audio data CD_{A} and the video data BD_{V} added with reference mark data D_{RM1}, which is one example of the reference mark data D_{RM}, at every time interval δ₁, Specifically, simultaneously when program A is started to be broadcasted, a first reference mark RM₁ is added as the reference mark data D_{RM1} Thereafter, reference marks RM₂, RM₃, . . . , are added at every time interval δ₁, that is, at the same time intervals T₂.

Also, during the time period TP₂, the broadcast stream S_{M} contains data resulted from multiplexing of the audio data CD_{A} and the video data BD_{V} added with reference mark data D_{RM2} which is another example of the reference mark data D_{RM} at every time interval δ₂. During the time period TP₃, the broadcast stream S_{M} contains data identical to that contained during the time period TP₁.

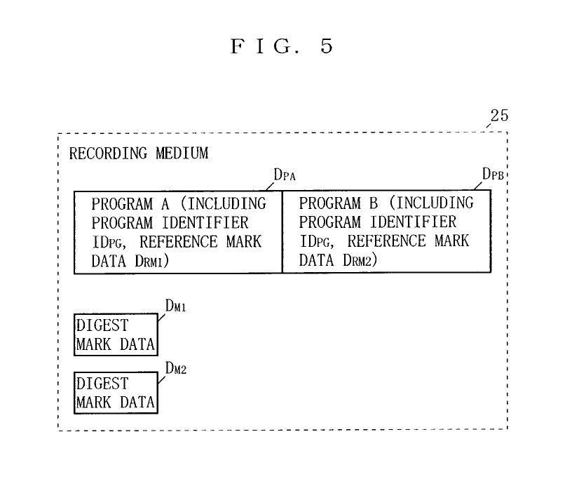

FIG. 4 is a block diagram illustrating a detailed structure of each of the reception apparatuses 2a and 2b illustrated in FIG. 1. Note that the reception apparatuses 2a and 2b have the same structure. Therefore, for description convenience, only the structure of the reception apparatus 2a is described. In FIG. 4, the reception apparatus 2a includes a digest mark data generation apparatus 21. The digest mark data generation apparatus 21 includes a tuner 22, a demultiplexer (DEMUX) 23, a recorder 24, a recording medium 25, an input unit 26, a program reader 27, an AV decoder 28, a display 29, a loudspeaker 210, a mark data generator 211, a digest reader 212, a mark data reader 213, and a communications unit 214.

Of processes performed by the above-structured digest mark data generation apparatus 21, a process of storing a program data D_{P} (that is, a process of recording a program) is described below. The tuner 22 receives a broadcast signal SB from an antenna (not shown), and then typically performs a demodulating process to obtain a broadcast stream SM. The broadcast stream S_{M} is then supplied to the DEMUX 23. The DEMUX 23 separates program data D_{P} composing a program designated by the user from the received broadcast stream S_{M} and then outputs the program data D_{P} to the recorder 24. The recorder 24 records the received program data D_{P} on the large-volume, randomly-accessible recording medium (hard disk or DVD-RAM, for example) 25. Therefore, when the tuner 22 is set so as to receive the broadcast stream S_{M} as illustrated in FIG. 3 during the time periods TP₁ and TP₂, and programs A and B are designated to be recorded, the recording medium 25 records program data D_{PA} Of program A and program data D_{PB} of program B, as illustrated in FIG. 5. FIG. 5 also illustrates the digest mark data D_{M1} and D_{M2} which will be described further below in detail.

Of the processes performed by the digest mark data generation apparatus 21, a process of generating digest mark data D_{M} which is one unique feature of the present invention, is now described below in detail. Prior to generation of digest mark data D_{M}, it is required that at least one piece of program data D_{P} composing a program has been recorded on the recording medium 25. To generate digest mark data D_{M}, the user first operates the input unit 26 in a predetermined manner to select one program for which digest mark data D_{M} should be generated. In response, the input unit 26 generates program designation data D_{PS} indicative of the selected program, and then transmits the generated program designation data D_{PS} to the program reader 27. The program reader 27 reads the program indicated by the program designation data D_{PS}, that is, the program data D_{P}, from the recording medium 25, and then forwards the read program to the AV decoder 28 and the mark data generator 211. As a result, the display 29 and the loudspeaker 210 produce video and audio represented by video data D_{V} and audio data D_{A} reproduced by the AV decoder 28. In this case, the reception apparatus 2a plays not a digest of the recorded program, but the recorded program itself.

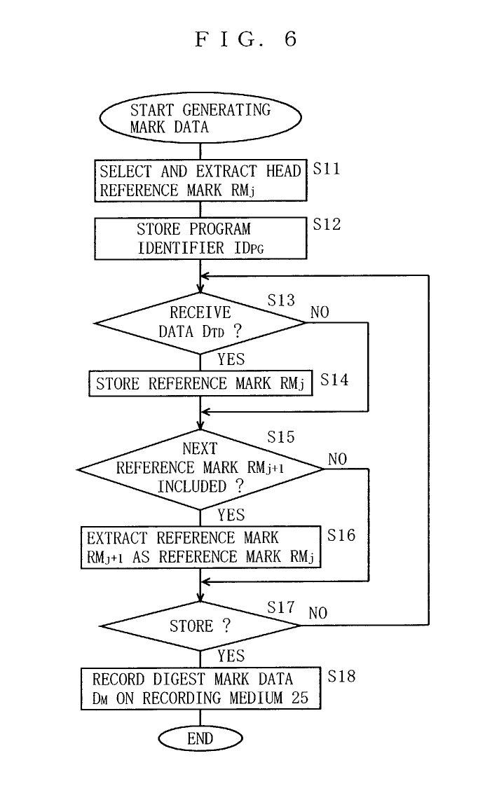

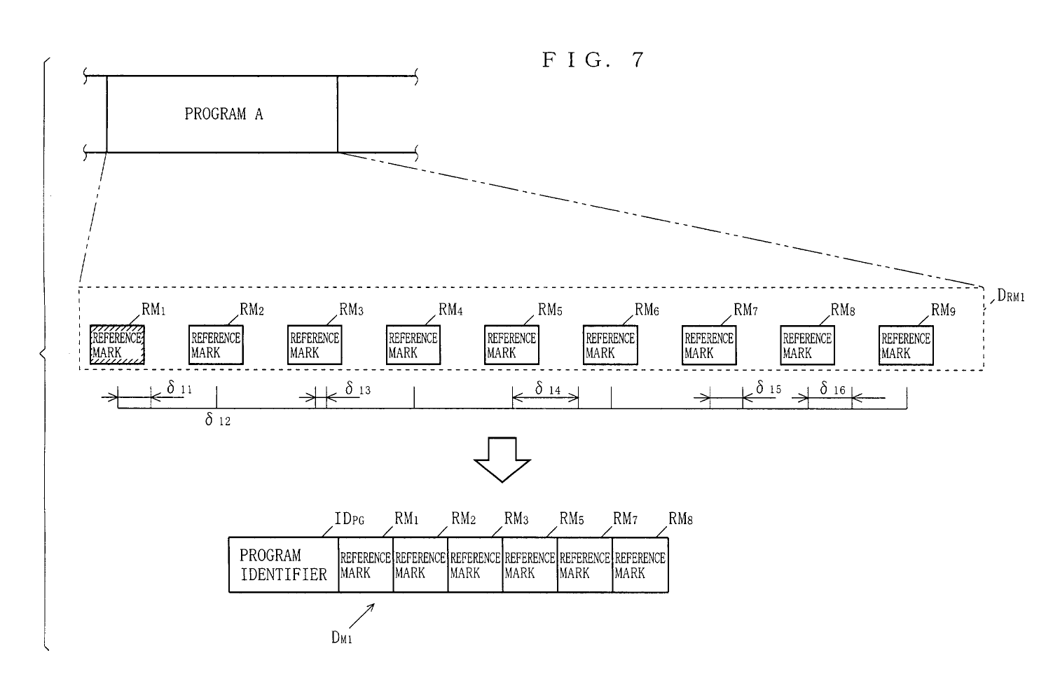

After receiving the program data D_{P}, the mark data generator 211 is caused to start the process of generating digest mark data D_{M} as shown in a flowchart of FIG. 6. Note herein that the mark data generator 211 has previously known a field (s) of the program data D_{P} where reference marks RMᵢ, and program identifiers ID_{PG} are to provided. Of these reference marks RM₁, to be provided, the mark data generator 211 selects a head reference mark RMⱼ (j=1, 2, 3, . . .) (step S11). Note herein that the reference mark RMⱼ selected in step S11 is not always a reference mark RM₁ because the recorded program is not always an entire program, but may have a missing part, for example, a beginning part.

The mark data generator 211 extracts a program identifier ID_{PG} from the program data D_{P} for storage in a storage area (not shown) reserved for generating digest mark data D_{M} (step S12).

Subsequent to step S12, the mark data generator 211 determines whether timing designation data D_{TD} has been received from the input unit 26 (step S13).

Here, the timing designation data D_{TD} is described below. The user operates the input unit 26 in a predetermined manner while viewing video images on the display 29. With this operation, the user designates a start and an end of each section desired as a digest (such a section is hereinafter referred to as a digest section). In response to each designation, the input unit 26 generates timing designation data D_{TD} indicative of user's operation timing, that is, the start and the end of the digest section, and then transmits the generated timing designation data D_{TD} to the mark data generator 211.

If it is determined in step S13 that the timing designation data D_{TD} has been received, the mark data generator 211 stores the presently-selected reference mark RMⱼ in the above-mentioned storage area as information indicative of timing at which the user operated the input unit 26, that is, information indicative of the start and the end of the digest section (step S14).

If it is determined in step S13 that no timing designation data D_{TD} has been received or after step S14 is performed, the mark data generator 211 determines whether the next reference mark RMⱼ₊₁ is included in the program data D_{P} received from the program reader 27 (step S15).

If it is determined in step S15 that the next reference mark RMⱼ₊₁ is included, the mark data generator 211 deletes the present reference mark RMⱼ, and then selects the found reference mark RMⱼ₊₁ as the reference mark RMⱼ (step S16)

If it is determined in step S15 that no next reference mark RM₊₁ is included or after step S16 is performed, the mark data generator 211 determines whether now is the time to store the digest mark data D_{M} (step S17). This determination can be made with various schemes. For example, if the program data D_{P} is no longer sent from the program reader 27, the mark data generator 211 regards the timing designation data D_{TD} as being no longer sent from the input unit 26, thereby determining that now is the time to store the digest mark data D_{M}. In another example, after receiving the user's operation of the input unit 26 for making an instruction of storing the digest mark data D_{M}, the mark data generator 211 determines that now is the time to store the digest mark data D_{M}.

If it is determined in step S17 that now is not the time to store the digest mark data D_{M}, the mark data generator 211 performs step S13 for continuing the process of generating the digest mark data D_{M}.

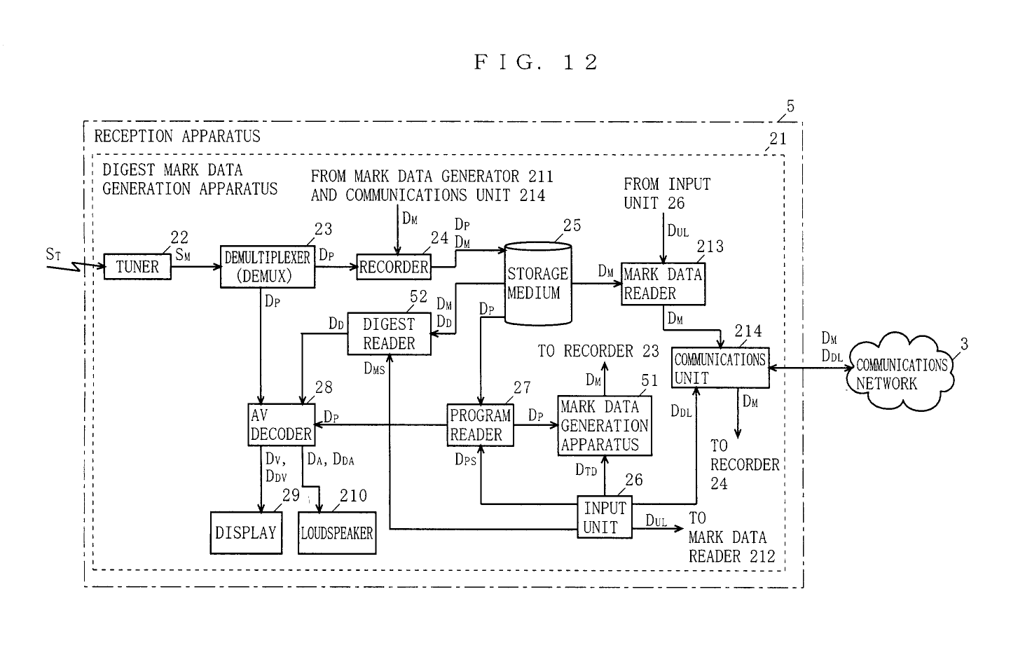

If it is determined in step S17 that now is the time to store the digest mark data D_{M}, the mark data generator 211 causes the recorder 24 to record, as the digest mark data D_{M}, the program identifier ID_{PG} and one or more reference marks RMᵢ stored in the storage area on the recording medium 25 (step S18) At this time, preferably, the digest mark data D_{M} is provided with a program title T_{PG} a total playing time T_{DG}, and a creator P_{CR} of the digest mark data in order to facilitate a sharing of the digest mark data D_{M} (refer to FIG. 11).

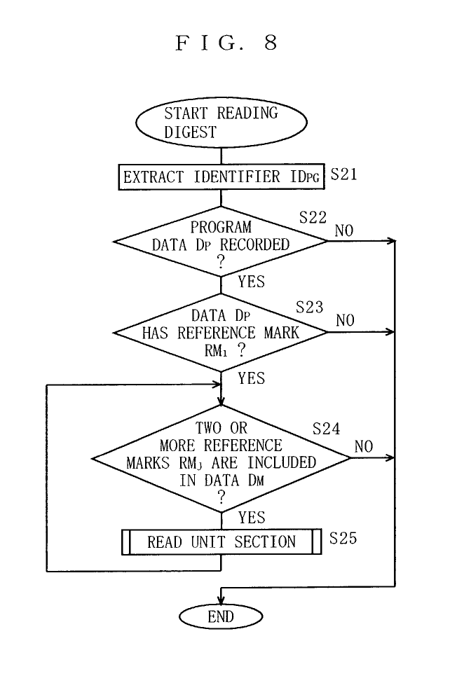

Exemplary digest mark data D_{M1} of the digest mark data D_{M} generated as a result of the above processes is described below. Now, assume herein that the user selects program A illustrated in FIG. 3 as a program for which the digest mark data D_{M} is to be generated. As a result, the display 29 outputs video of program A, while the loudspeaker 210 outputs audio thereof in synchronization with the output video. While viewing program A, the user operates the input unit 26 several times at desired occasions. More specifically, the user first operates the input unit 26 after a lapse of a time δ₁₁ (δ₁₁<δ₁) from the time indicated by the reference mark RM₁. In this case, instep S14, the reference mark RM₁ is stored. Then, if the user operates the input unit 26 after a lapse of a time δ₁₂ (δ₁₂≈0) from the time indicated by the reference mark RM₂, the reference mark RM₂ is stored in step S14. Thereafter, similarly, if the user operates the input unit 26 after a lapse of a time δ₁₃ from the time indicated by the reference mark RM₃; after a lapse of a time δ₁₄ from the time indicated by the reference mark RM₅; after a lapse of a time δ₁₅ from the time indicated by the reference mark RM₇; and after a lapse of a time δ₁₆ from the time indicated by the reference mark RM₈, the reference marks RM₃, RM₅, RM₇, and RM₈ are stored, respectively, in step S14. In this case, the digest mark data DM₁ of FIG. 5 recorded in step S18 on the recording medium 25 is composed of the identifier ID_{PG} of program A and the reference marks RM₁, RM₂ RM₃, RM₅, RM₇, and RM₈ (refer to FIG. 7). Digest mark data DM₂, which is another example of the digest mark data D_{M}, is generated in a manner similar to that of the digest mark data DM₁, and is then recorded on the recording medium 5.

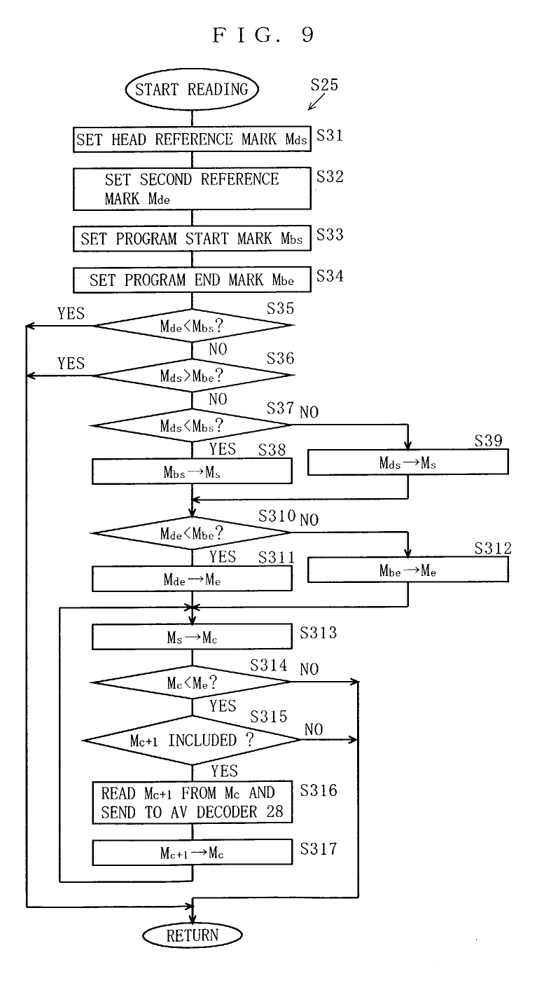

Of the processes performed by the digest mark data generation apparatus 21, a process of playing a digest, which is yet another unique feature of the present invention, is now described below in detail. To play the digest, the user first operates the input unit 26 in a predetermined manner to select one piece of digest mark data D_{M} recorded on the recording medium 25. In response, the input unit 26 generates mark designation data D_{MS} indicative of the selected digest mark data D_{M} for transmission to the digest reader 212. After receiving the mark designation data D_{MS} the digest reader 212 regards that now is the time to start the process of playing the digest as shown in a flowchart of FIG. 8.

First, the digest reader 212 reads the digest mark data D_{M} indicated by the mark designation data D_{MS} (such digest mark data is hereinafter referred to as target digest mark data D_{M}) from the recording medium 25 for retrieving the program identifier ID_{PG} (step S21). The digest reader 212 then determines whether the program data D_{P} having a program identifier that coincides with the program identifier ID_{PG} extracted in step S21 (such program data is hereinafter referred to as target program data D_{P}) has been recorded on the recording medium 25 (step S22).

Note herein that, as will be described further below, the target digest mark data D_{M} generated by the reception apparatus 2a can also be used by the reception apparatus 2b. However, the target digest mark data D_{M} is not always stored in both of the reception apparatuses 2a and 2b. For this reason, the reception apparatus 2 performs steps S21 and S22 to determine whether the target data D_{P} has been recorded on the recording medium 25.

If it is determined in step S22 that the target program data D_{P} has not been recorded, the digest reader 212 cannot read the target program data D_{P}. Therefore, the process of FIG. 8 ends.

If it is determined in step S22 that the target program data D_{P} has been recorded, the digest reader 212 determines whether the target program data D_{P} has been provided with at least one reference mark RMᵢ, (step S23).

As described above, the target digest mark data D_{M} can be shared by the reception apparatuses 2a and 2b. However, the reception apparatuses 2a and 2b do not necessarily record exactly the same target program data D_{P}. For example, the reception apparatus 2a records the entire target program data D_{P}, while the reception apparatus 2b records only a small portion of the target program data D_{P}. For this reason, the reception apparatus 2 performs step S23 to determine whether the target program data D_{P} has been provided with at least one reference mark RMᵢ.

If it is determined in step S23 that the target program data D_{P} has not been provided with the reference mark RMᵢ, the digest reader 212 cannot read the target program data D_{P}, and therefore ends the process of FIG. 8.

If it is determined in step S23 that the target program data D_{P} has been provided with the reference mark RMᵢ, the digest reader 212 determines whether two or more reference marks RMⱼ, are included in the digest mark data D_{M} read in step S21 (step S24).

If it is determined in step S23 that two or more reference marks RMⱼ are not included in the target program data D_{P}, the digest reader 212 regards the reading of the digest as completed, and ends the process of FIG. 8.

If it is determined that the reference marks RMᵢ are included in the target program data D_{P}, the digest reader 212 carries out a process of reading a unit section of the target program data D_{P} (step S25). Here, the unit section is a portion of the target program data D_{P} read at a time in step S25, and will be described further below in detail.

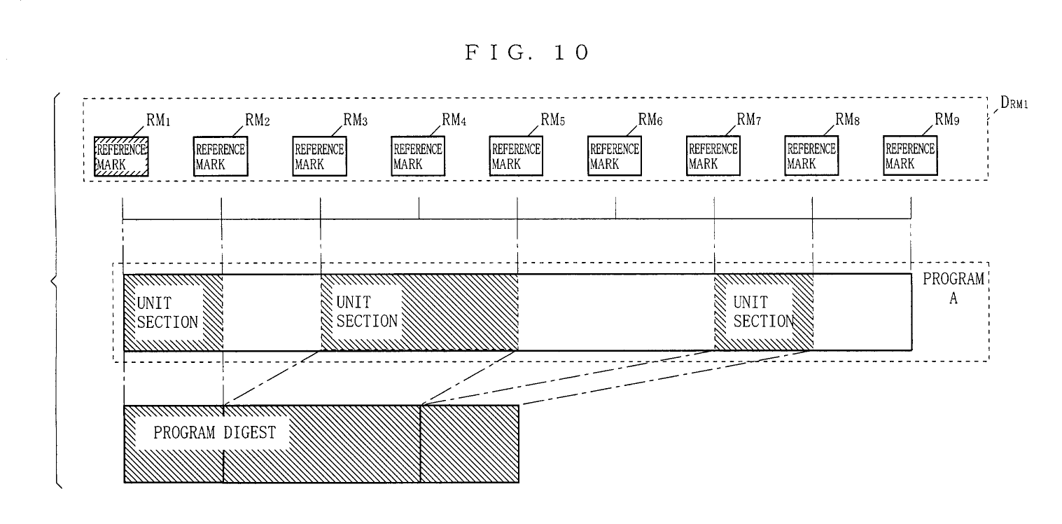

FIG. 9 is a flowchart showing the detailed process of step S25. In FIG. 9, the digest reader 212 searches unselected reference marks RMⱼ of the target digest mark data D_{M} for a reference mark RMⱼ located at the head (that is, the one having minimum j in the target digest mark data D_{M}) The digest reader 212 then sets the found reference mark as a head reference mark M_{ds} serving as an index of a starting position of the unit section (step S31).

Furthermore, the digest reader 212 sets a second reference mark RMⱼ following the reference mark RMⱼ selected in step S31 as a second reference mark M_{de} serving as an index of an end position of the unit section (step S32).

The digest reader 212 then searches for the first reference mark RM₁ firstly provided to the target program data D_{P} (that is, the one having minimum i in the target program data D_{P}), and sets the found first reference mark RMᵢ as a program start mark M_{bs} (step S33). Note herein that the first reference mark RMᵢ is not necessarily the reference mark RM₁, as described above.

Furthermore, the digest reader 212 sets a last reference mark RMᵢ lastly provided to the target program data D_{P} (that is, the one having maximum i in the target program data D_{P}) as a program end mark M_{be} (step S34).

The digest reader 212 determines whether the second reference mark M_{de} is smaller in value on the time axis than the program start mark M_{bS} (step S35). If M_{de} <M_{bs}, this means that the end position of the present unit section precedes the start position of the program represented by the target program data D_{P}. In this case, the present unit section cannot be read. Therefore, the digest reader 212 ends the process of FIG. 9.

If M_{de}≧M_{bs}, the digest reader 212 determines whether the head reference mark M_{ds} is larger than the program end mark M_{be} (step S36).

If M_{ds}>M_{be} in step S35, this means that the head reference mark M_{ds} is located after the end position of the program represented by the target program data D_{P}. In this case, the present unit section cannot be read. Therefore, the digest reader 212 ends the process of FIG. 9.

As described above, the target digest mark data DM can be shared between the reception apparatuses 2a and 2b. Furthermore, the target program data DP is not necessarily recorded in both the reception apparatuses 2a and 2b under exactly the same conditions. Therefore, in some cases, the entire sections of the target program data D_{P} designated by the target digest mark data D_{M} may not be recorded in the reception apparatus 2b. For this reason, the digest reader 212 performs steps S35 and S36 to determine whether a portion corresponding to the present unit section has been recorded on the recording medium 25. If such a portion cannot be found, the process of FIG. 9 ends.

If M_{ds}≦M_{be} instep S36, the digest reader 212 determines whether the head reference mark M_{ds} is smaller than the program start mark M_{bs} (step S37).

If M_{ds}<M_{bs}, the target program data D_{P} cannot be read from the portion corresponding to the head reference mark M_{ds}. Therefore, the digest reader 212 sets the program start mark M_{bs} as a mark defining a start position of a unit section of a digest (such a mark is hereinafter referred to as a digest start mark Mₛ) (step S38).

If M_{ds}≧M_{bs} the digest reader 212 sets the head reference mark M_{ds} as the digest start mark Mₛ (step S39)

Subsequent to either one of steps S38 and S39, the digest reader 212 determines whether the second reference mark M_{de} is smaller than the program end mark M_{be} (step S310).

If M_{de}<M_{be}, the digest reader 212 sets the second reference mark M_{de} as a mark defining an end position of the unit section (such a mark is hereinafter referred to as a digest end mark Mₑ) (step S311)

If M_{de}≧M_{be}, the digest reader 212 cannot read the target program data D_{P} until the time indicated by the second reference mark M_{de} comes. Therefore, the digest reader 212 sets the program end mark M_{be} as the digest end mark Mₑ (step S312).

As described in the foregoing, in the present embodiment, the unit section means a portion of the target program data D_{P} defined by the digest start mark Mₛ and the digest end mark Mₑ.

Subsequent to either one of steps S311 and S312, the digest reader 212 sets the digest start mark Mₛ as a reference mark RMᵢ designating a position of the program data D_{P} to be played this time (such a mark is hereinafter referred to as a current position mark M_{c}) (step S313).

The digest reader 212 then determines whether the current position mark M_{c} is larger than the digest end mark Mₑ (step S314).

If M_{c}≧Mₑ, the digest reader 12 regards that the reading of the unit section as completed, and then ends the process of FIG. 9.

If M_{c}<Mₑ, the digest reader 212 determines whether the target program data D_{P} includes a reference mark RMᵢ that immediately follows the current position mark M_{c} and is not the digest end mark Mₑ (such a reference mark RMᵢ hereinafter referred to as a next mark M_{c+1}) (step S315).

If the target program data D_{P} does not include such a next mark M_{c+1}, the digest reader 212 regards that the reading of the unit section as completed, and then ends the process of FIG. 9.

If the target program data D_{P} includes such a next mark M_{c+1}, the digest reader 212 reads, from the recording medium 25, a portion defined by the current position mark M_{c} and the next mark M_{c+1} as digest data D_{D} for transmission to the AV decoder 28 (step S316) As a result, the display 29 and the loudspeaker 210 output video and audio representing part of the digest based on the video data D_{DV} and the audio data D_{DA} reproduced by the AV decoder 28. Subsequent to step S315, the digest reader 212 sets the next mark M_{c+1}, as the current position mark M_{c} (step S317), and then returns to step S313.

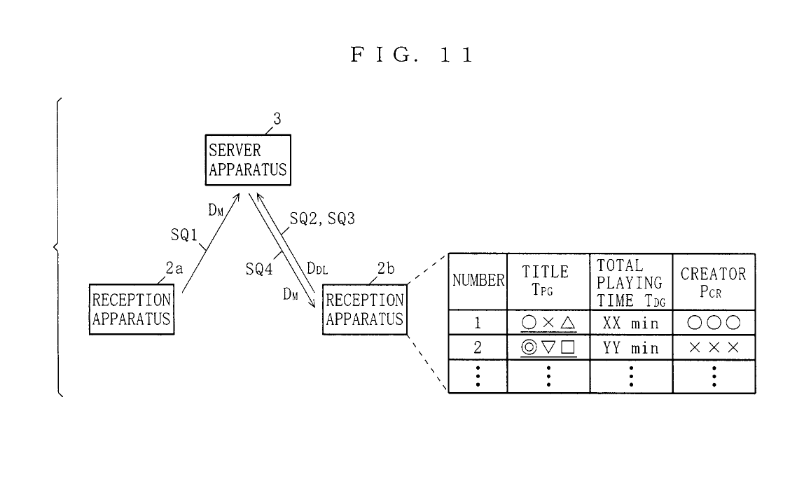

An exemplary program digest resulted from the above-described processes is described below. Now, assume herein that the user selects the digest mark data D_{M1} to view a digest of program A illustrated in FIG. 3. Under this assumption, after the processes of FIGS. 8 and 9 has been completed, video and audio corresponding to diagonally shaded portions in FIG. 10 defined by the reference marks RM₁ and RM₂ of program A are first produced from the reception apparatus 2a. Then, video and audio corresponding to a portion defined by the reference marks RM₂ and RM₃ are not produced, and then those corresponding to a portion defined by reference marks RM₃ and RM₅ are produced from the reception apparatus 2a. Then, video and audio corresponding to a portion defined by the reference marks RM₅ and RM₇ are not produced, and then those corresponding to a portion defined by reference marks RM₇ and RM₈ are produced from the reception apparatus 2a.

Of the processes performed by the digest mark data generation apparatus 21, a process of uploading the digest mark data D_{M}, which is a still another unique feature of the present invention, is now described below in detail. The user first operates the input unit 26 in a predetermined manner to select digest mark data desired to be uploaded from the pieces of digest mark data D_{M} recorded on the recording medium 25. Furthermore, the user operates the input unit 26 to designate the server apparatus 3 to which the selected digest mark data D_{M} is to be uploaded. In response, the input unit 26 generates an upload request D_{UL} indicative of the selected pieces of digest mark data D_{M} and the designated server apparatus 3 for transmission to the mark data reader 213. After receiving the upload request D_{UL}, the mark data reader 213 reads those pieces of digest mark data D_{M} designated by the upload request D_{UL} (hereinafter referred to as target digest mark data D_{M}) from the recording medium 25. Then, as illustrated in FIG. 11, the mark data reader 213 transmits the target digest mark data D_{M} to the server apparatus 3 via the communications unit 214 and the communications network 4 (sequence SQ1).

After receiving the target digest mark data D_{M}, the server apparatus 3 assigns a number to the received target digest mark data D_{M}, and extracts therefrom the title T_{PG}, the total playing time T_{DG}, and the creator P_{CR} Then, the server apparatus 3 presents the digest mark data D_{M} so as to allow the other reception apparatus 2b to download the digest mark data D_{M} (refer to FIG. 11).

Of the processes performed by the digest mark data generation apparatus 21, a process of downloading the digest mark data D_{M}, which is yet another unique feature of the present invention, is now described below. According to a user's operation of the input unit 26, the reception apparatus 2b accesses to the server apparatus 3 (sequence SQ2). Furthermore, referring to a display screen as illustrated in FIG. 11, the user operates the input unit 26 to select desired digest mark data from the uploaded pieces of the digest mark data D_{M}. In response, the input unit 26 of the reception apparatus 2b generates a download request D_{DL} indicative of the selected digest mark data D_{M} for transmission to the server apparatus 3 via the communications unit 214 and the communications network 4 (sequence SQ3).

The server apparatus 3 transmits the digest mark data D_{M} designated by the download request D_{DL} to the reception apparatus 2b via the communications network 4 (sequence SQ4). Then, in the reception apparatus 2b, the communications unit 214 forwards the received digest mark data D_{M} to the recorder 24. The recorder 24 records the received digest mark data D_{M} on the recording medium 25. Therefore, in the reception apparatus 2b, the digest mark data generation apparatus 21 performs the process of FIGS. 8 and 9 under the condition that the program data D_{P} specified by the program identifier ID_{PG} contained in the digest mark data D_{M} has been recorded on the recording medium 25. With this, the user can view the digest played based on the digest mark data D_{M} generated by the reception apparatus 2a.

As described above, according to the present invention, the broadcast station 1 provides the video data CD_{V} with the reference mark data D_{RM} to generate embedded video data BD_{V}. Such embedded video data BD_{V} is multiplexed on the broadcast stream S_{M} by the MUX 13, and is then broadcasted as a broadcast signal S_{B}. The reception apparatus 2a generates the digest mark data D_{M} by using the reference mark data D_{RM} according to the user's operation of the input unit 26. As such, the digest mark data D_{M} is generated from the reference mark data D_{RM} embedded in the video data CD_{V} irrespectively of information about preferences of the user of the reception apparatus 2a. Thus, the user can give such digest mark data D_{M} to others at ease. As evident from the above, according to the present embodiment, it is possible to provide a reception apparatus 2 suited for a sharing of a program digest.

Furthermore, according to the present embodiment, the reception apparatus 2 performs the processes described with reference to FIGS. 8 and 9 in consideration that the program data D_{P} has possibly been stored in another reception apparatus 2 under different conditions. With this, it is possible to provide a reception apparatus 2 more suited for a sharing of the digest mark data D_{M}.

Still further, since the video data CD_{V} is provided with the reference mark data D_{RM}, the broadcast station 1 can easily rerun the program. For example, with reference to FIG. 3, when program A is scheduled to be first run during the time period TP₁ and is also scheduled to be rerun during the time TP₃, the embedded video data BD_{V} of program A is saved in the program storage section 11 after the first run. At the time of rerun, the saved embedded video data BD_{V} can be used. With this, the reference mark data D_{RM} does not have to be provided at the time of rerun.

Still further, as described above, the same video data BD_{V} is used at both first run and rerun. Therefore, by using the digest mark data D_{M} generated by viewing the program at the first run or the rerun, the reception apparatus 2 can play the same digest again from out of the program data D_{P} recorded at the first run or the rerun.

Still further, the reception apparatus 2 generates the digest mark data D_{M} from the reference mark RMⱼ held at the time of the user's operation of the input unit 26 (refer to steps S13 and S14). With this, the digest mark data D_{M} can be generated more easily, compared with a modified example that will be described further below. This generation scheme is especially effective in a case where the time interval T₂ is sufficiently short. This is because, in such a case, the time of the user's operation can be approximate to the time indicated by the reference mark RMᵢ.

In the above embodiment, the stream generation apparatus 12 is exemplarily applied to the broadcast station 1. This is not meant be restrictive. Alternatively, the stream generation apparatus 12 can be singly used by a program creator, or can be applied to a server apparatus that distributes programs over the Internet.

Furthermore, in the above embodiment, the reference mark data D_{RM} is embedded in a reserved field of the video data CD_{V}. This is not meant to be restrictive. Alternatively, the reference mark data D_{RM} can be multiplexed on the video data CD_{V} by the MUX 13.

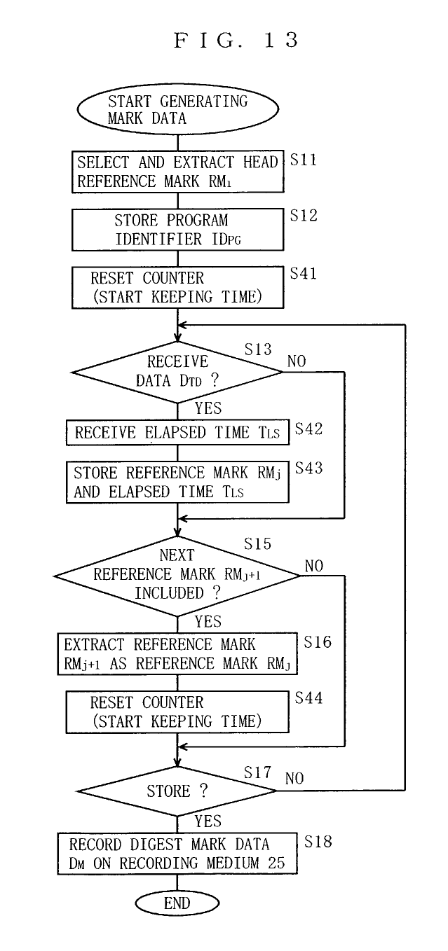

A reception apparatus 5 according to a modification example of the above-described reception apparatus 2 is now described below. FIG. 12 is a block diagram illustrating a detailed structure of the reception apparatus 5 according to the modification example. In FIG. 12, the reception apparatus 5 is different from the reception apparatus 2 of FIG. 4 only in that the digest mark data generation apparatus 21 includes a mark data generation apparatus 51 and a digest reader 52, instead of the mark data generator 211 and the digest reader 212. Therefore, in FIG. 12, components equivalent in structure to those in FIG. 5 are provided with the same reference numerals, and are not described herein.

Of the processes performed by the digest mark data generation apparatus 21, a process of generating digest mark data D_{M} (that is, an operation of the mark data generation apparatus 51), which is one unique feature of the present modification example, is now described below. As with the above-described embodiment, for the purpose of generating digest mark data D_{M}, the program reader 27 reads the program data D_{P} to be played from the recording medium 25, and sends the read target program data D_{P}, to the AV decoder 28 and the mark data generation apparatus 51. With this, the reception apparatus 5 plays the recorded program, but not a digest thereof.

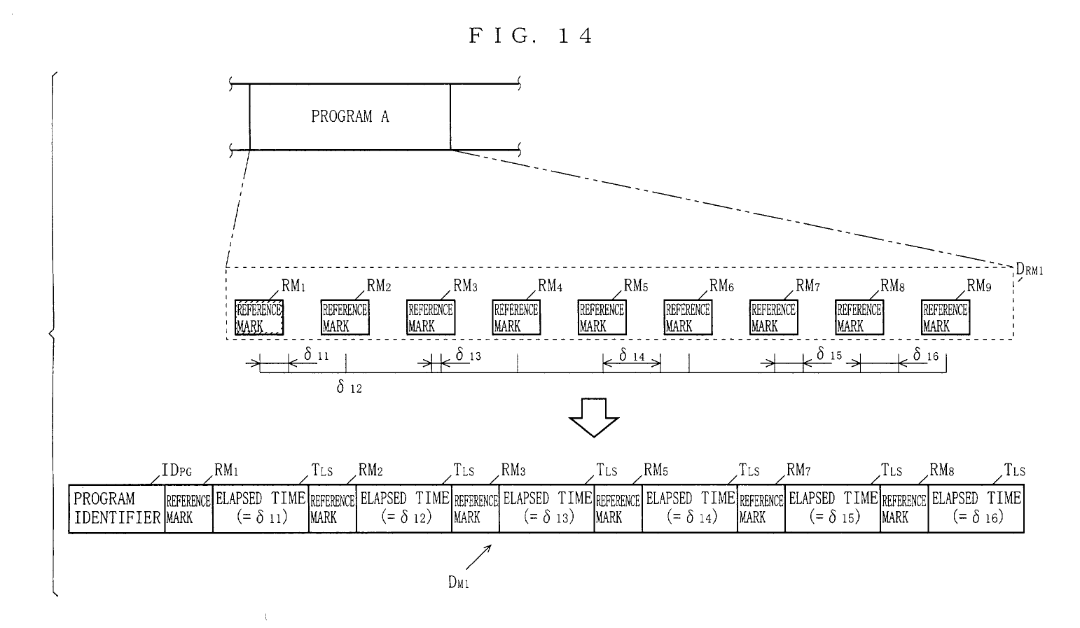

After receiving the program data D_{P} from the program reader 27, the mark data generation apparatus 51 starts a process shown in a flowchart of FIG. 13. FIG. 13 is different from FIG. 6 only in that steps S41 through S44 are included and step S14 is omitted. Therefore, in FIG. 13, steps equivalent to those in FIG. 6 are provided with the same step numbers, and are not described herein.

Subsequent to step S12, the mark data generation apparatus 51 resets a counter (not shown) (step S41). The counter counts an elapsed time T_{LS} from a time of the resetting. Subsequent to step S41, the mark data generation apparatus 51 performs step S13.

If it is determined in step S13 that the timing designation data D_{TD} has not been received, the mark data generation apparatus 51 performs step S15, as with the mark data generator 211.

If it is determined in step S13 that the timing designation data D_{TD} has been received, the mark data generation apparatus 51 receives the elapsed time T_{LS} counted by the counter (step S42). Then, the mark data generation apparatus 51 stores a set of the currently-selected reference mark RMᵢ and the received elapsed time T_{LS} in a storage area for generating the digest mark data D_{M} (step S43).

As such, unlike the above-described embodiment, the set of the reference mark RMᵢ and the received elapsed time T_{LS} is stored in the storage area in the modification example. Therefore, the time of the user's operation is defined as a time after the time T_{LS} elapses from the time indicated by the reference mark RMᵢ. With this, the time of the user's operation can be stored more accurately by using the storage area, compared with the above-described embodiment.

If it is determined in step S13 that the timing designation data D_{TD}, has not been received or after step S43 is performed, the mark data generation apparatus 51 performs step S15. If it is determined in step S15 that the next reference mark RMⱼ₊₁ is included, the mark data generation apparatus 51 performs step S16, and then resets the counter (step S44), as with step S41. If it is determined in step S15 that the next reference mark RM₊1 is included or after step S44 is performed, the mark data generation apparatus 51 performs step S18 only if it is determined in step S17 that now is the time to store the digest mark data D_{M}.

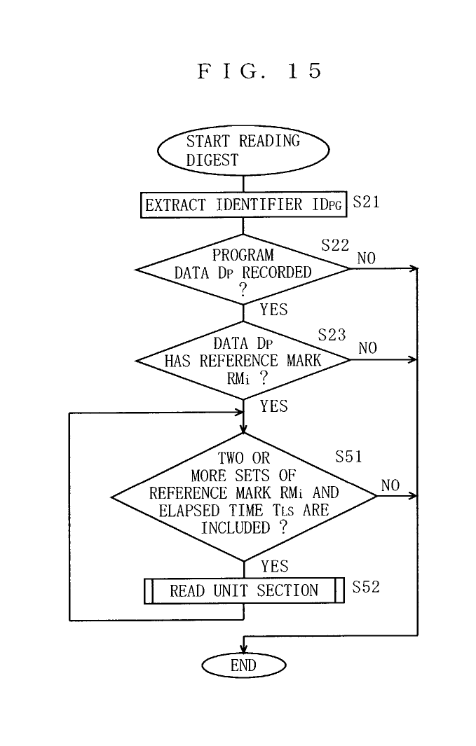

Unlike the above-described embodiment, such digest mark data D_{M1} as exemplarily described below is generated as one example of the digest mark data D_{M} after the above-described processes in the modification example. Now, assume herein that the user selects program A illustrated in FIG. 3 as a program for which the digest mark data D_{M} is to be generated. As a result, the display 29 outputs video of program A, while the loudspeaker 210 outputs audio thereof in synchronization with the output video. While viewing program A, the user operates the input unit 26 several times at desired occasions. More specifically, the user first operates the input unit 26 after a lapse of the time δ₁₁, δ_{11 <δ}₁) from the time indicated by the reference mark RM₁. In this case, the elapsed time T_{LS} received in step S42 indicates the time δ₁₁. In step S42, a set of the reference mark RM₁ and the time δ₁₁ is stored. Then, the user operates the input unit 26 after a lapse of the time δ₁₂ (δ₁₂≈0) from the time indicated by the reference mark RM₂. In this case, a set of the reference mark RM₂ and the time δ₁₂ as the elapsed time T_{LS} is stored in step S14. Thereafter, similarly, a set of the reference mark RM₃ and the elapsed time T_{LS} (=δ₁₃); a set of the reference mark RM₅ and the elapsed time T_{LS} (=δ₁₄); a set of the reference mark RM₇ and the elapsed time T_{LS} (=δ₁₅); and a set of the reference mark RM₈ and the elapsed time T_{LS} (=δ₁₆) are stored. In this case, the digest mark data DM₁ as illustrated in FIG. 14 are stored in step S18 on the recording medium 25.

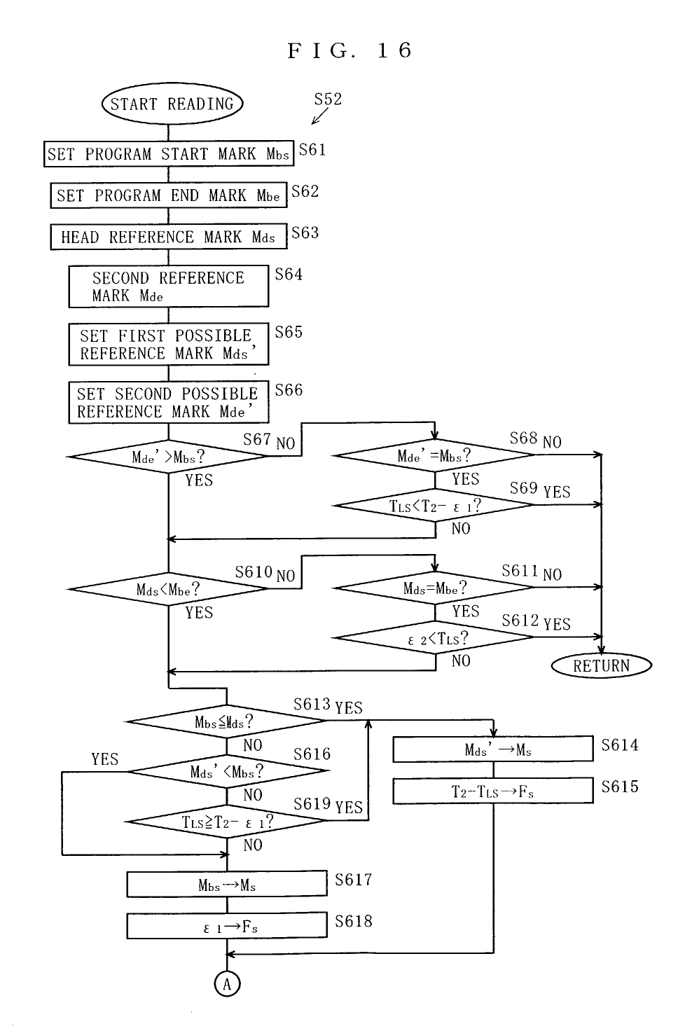

Of the processes performed by the digest mark data generation apparatus 21, a process of playing a digest, which is yet another unique feature of the modification example, is now described below in detail. As with the above-mentioned embodiment, after receiving the mark designation data D_{MS}, the digest reader 52 regards that now is the time to start the process of playing the digest as shown in a flowchart of FIG. 15. FIG. 15 is different from FIG. 8 only in that steps S24 and S25 are replaced with steps S51 and S52. Therefore, in FIG. 15, steps equivalent to those in FIG. 8 are provided with the same step numbers, and are not described herein.

If it is determined in step S23 that the target program data D_{P} has been provided with the reference mark RMᵢ, the digest reader 52 determines whether the digest mark data D_{M} read in step S21 (hereinafter referred to as target digest mark data D_{M}) includes two or more sets of the reference mark RMᵢ and the elapsed time T_{LS} (step S51).

If it is determined that the target digest mark data D_{M} does not include two or more such sets, the digest reader 52 regards the process of playing the digest as completed, and ends the process of FIG. 15. If it is determined that the target digest mark data D_{M} includes two or more such sets, the digest reader 52 performs the process of reading a unit section (step S52)

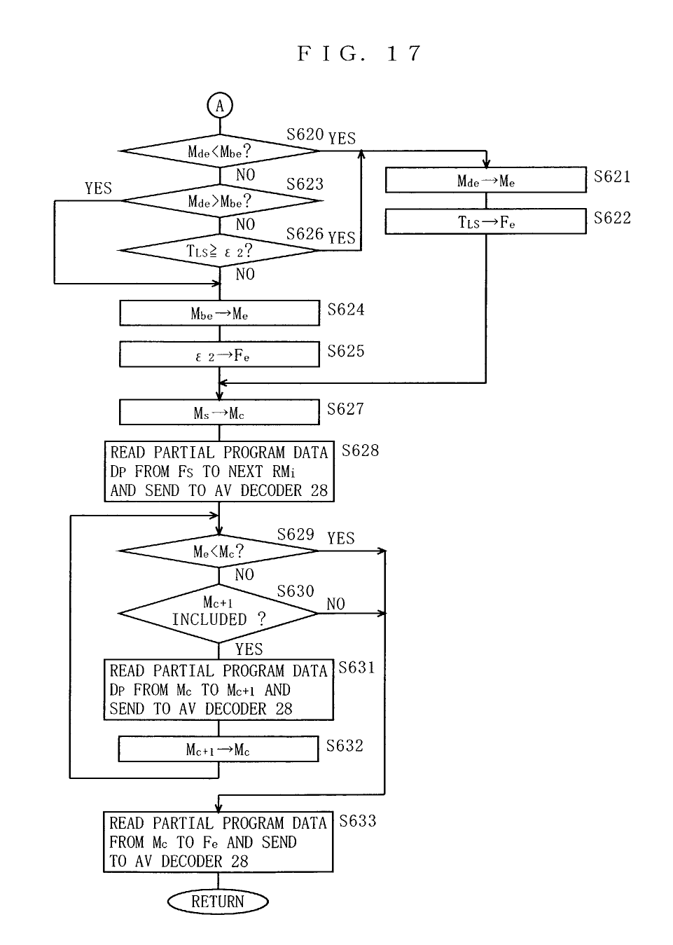

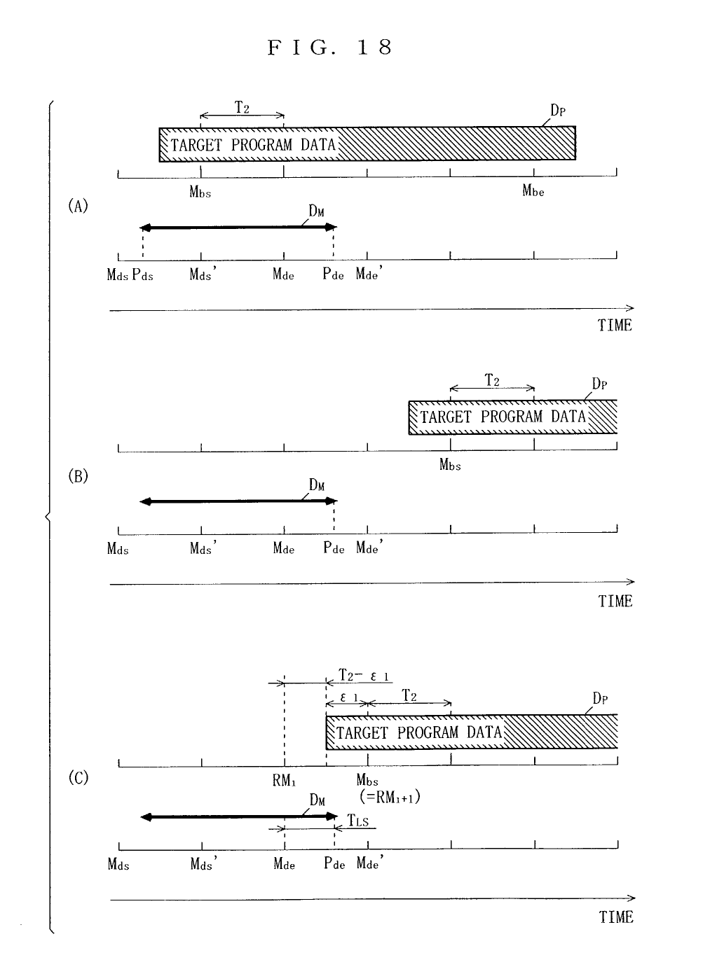

FIG. 16 shows a first-half of a flowchart showing a detailed process of step S52, and FIG. 17 shows a latter-half thereof. In FIG. 16, the digest reader 52 first sets the program start mark M_{bs} and the program end mark M_{be}, which have been described in the above embodiment (steps S61 and S62). The digest reader 52 then searches the unselected sets composing the target digest mark data D_{M} for a set of a reference mark RMⱼ located at the head of the target digest mark data D_{M} and the elapsed time T_{LS} (that is, a set including the reference mark RMⱼ having minimum j), and sets the found reference mark RMⱼ as the head reference mark M_{ds}, which has also been described in the above embodiment (step S63). Note that a position specified by the head reference mark M_{ds} and the elapsed time T_{LS} is hereinafter called a head reference position P_{ds}.

The digest reader 52 then searches the target digest mark data D_{M} for a set of a reference mark RMⱼ located second to the head (that is, one immediately following the reference mark RMⱼ found in step S63) and the elapsed time T_{LS}, and sets the found reference mark RMⱼ as the second reference mark M_{de}, which has also been described in the above embodiment (step S64). Note that a position specified by the second reference mark M_{de} and the elapsed time T_{LS} is hereinafter called an end reference position P_{de}.

The digest reader 52 then sets a reference mark RMᵢ immediately after the head reference mark M_{ds} in the target program data D_{P} as a first possible reference mark M_{ds}′ (step S65)

The digest reader 52 then sets a reference mark RMᵢ immediately after the end reference mark M_{de} in the target program data D_{P} as a second possible reference mark M_{de}′ (step S66).

For example, when the head reference mark M_{ds} is the reference mark RM₁ (refer to FIG. 14), the reference mark RM₂ is set in step S65 as the first possible reference mark M_{ds}′. Further, when the second reference mark M_{de} is the reference mark RM₂, the reference mark RM₃ is set in step S66 as the second possible reference mark M_{ds}′.

Next, for the purpose of eliminating a case where the present unit section of the target program data D_{P} cannot be played, the digest reader 52 checks to see whether the present unit section is located before the preceding time period in the target program data D_{P}. Such a check is performed in consideration that the shared digest mark data D_{M} may have been recorded in a reception apparatus other than the creator of the digest mark data D_{M} under conditions different from those of the creator. In view of this, the digest reader 52 determines whether the second possible reference mark M_{ds}′ is larger than the program start mark M_{bs} (step S67).

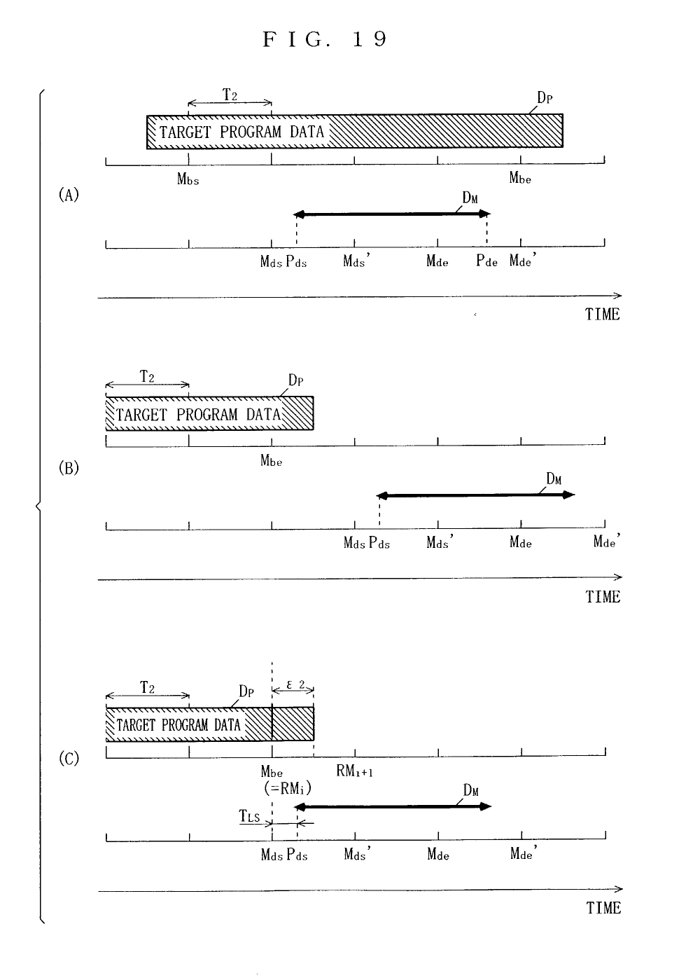

If M_{de}′>M_{bs}, as illustrated in (A) of FIG. 18, the end reference position P_{de} is located after the start position of the target program data D_{P}. That is, a section defined by the head reference position P_{ds} and the end reference position P_{de} overlaps in time with a section of the target program data D_{P} defined by its start and end positions. Therefore, the digest reader 52 determines that the present unit section can be played, and continues the process.

As illustrated in (B) of FIG. 18, if M_{de}′<M_{bs}, the digest reader 52 determines whether the second possible reference mark M_{de}′ is equal to the program start mark M_{bs} (step S68).

If M_{de}′≠M_{bs} as illustrated in (B) of FIG. 18, the end reference position P_{de} precedes the start position of the target program data D_{P}. Therefore, the digest reader 52 determines that the unit section cannot be read, and ends the process of FIG. 16.

As illustrated in (C) of FIG. 18, if M_{de}′=M_{bs}, the end reference position P_{de} and the start position of the target program data D_{P} are located between successive two reference marks RMᵢ and RMᵢ₊₁. In this case, between these two reference marks RMᵢ and RMᵢ₊₁, the digest reader 52 has to compare a time interval defined by the reference mark RMᵢ and the end reference position P_{de} and a time interval defined by the start position of the target program data D_{P} and the reference mark RMᵢ₊₁. Here, the start position of the program data D_{P} is taken as (RMᵢ₊₁−ε₁). ε₁ is a time defined by the start position of the program data D_{P} and the reference mark RMᵢ₊₁, and can be calculated from header information of the program data D_{P}. Also, here, RMᵢ₊₁−RMᵢ=T₂ (constant value). Therefore, the start position of the program data D_{P} can also be represented by (RMᵢ+T₂−ε₁). Furthermore, the end reference position P_{de} is (RMᵢ+T_{LS}). Therefore, if M_{de}′=M_{bs} in step S68, the digest reader 52 determines whether the elapsed time T_{LS} is smaller than the time (T₂−ε₁) (step S69).

As evident from (C) of FIG. 18, if T_{LS}<(T₂−ε₁), the end reference position P_{de} precedes the start position of the target program data D_{P}. Therefore, the digest reader 52 determines that the present unit section cannot be played, and ends the process of FIG. 16.

As illustrated in (C) of FIG. 18, if T_{LS}≧(T₂−ε₁) the end reference position P_{de} is located at a position after the start position of the target program data D_{P}. That is, the section defined by the head reference position P_{ds} and the end reference position P_{de} overlaps in time with the section of the target program data DP defined by the start position and the end position. Therefore, in this case, the digest reader 52 determines that the unit section can be read, and then proceeds to step S610.

In the foregoing, the reference mark RMᵢ is taken as a reference. Alternatively, the reference mark RMᵢ₊₁ can be taken as the reference. That is, the end reference position P_{de} can be represented by (RMᵢ₊₁−(T₂−T_{LS})). Also, since the start position of the target program data D_{P} is (RMᵢ₊₁−ε₁), the digest reader 52 may alternatively determine in step S69 whether the time (T₂−T_{LS}) is larger than the time ε₁. Here, if the time (T₂−T_{LS}) is larger than the time ε₁, this means that the elapsed time T_{LS} is smaller than (T₂−ε₁).

The digest reader 52 then checks to see whether the head reference position P_{ds} is located at a position after the target program data D_{P}. Such a check is performed in consideration of that the digest data D_{M} may have been recorded in a reception apparatus other than the creator of the digest mark data D_{M} under conditions different from those of the creator. For this check, the digest reader 52 determines whether the head reference mark M_{ds} is smaller than the program end mark M_{be} (step S610).

As illustrated in (A) of FIG. 19, if M_{ds}<M_{be}, it is regarded that the head reference mark M_{ds} precedes the end position of the target program data D_{P}. That is, the section defined by the head reference position P_{ds} and the end reference position P_{de} overlaps in time with the section of the target program data D_{P} defined by the start position and the end position. In this case, the digest reader 52 determines that the unit section can be read, and then performs step S613.

As illustrated in (B) of FIG. 19, if M_{ds}≧M_{be}, the digest reader 52 determines whether the head reference mark M_{ds} is equal to the program end mark M_{be} (step S611).

As illustrated in (B) of FIG. 19, if M_{ds}>M_{be}, the present head reference position P_{ds} is located at a position after the end position of the target program data D_{P}. That is, the section defined by the head reference position P_{ds} and the end reference position P_{de} does not overlap in time with the section of the target program data D_{P} defined by the start position and the end position. In this case, the digest reader 52 cannot read the unit section, and therefore ends the process of FIG. 16.

As illustrated in (C) of FIG. 19, if M_{ds}=M_{be}, in the same viewpoint as that of step S69, the digest reader 52 determines whether the elapsed time T_{LS} is larger than a time ε₂ (step S612). Here, the time ε₂ is a time defined by a time indicated by the reference mark RMᵢ and a time indicated by the end position of the program data D_{P}, and can be calculated from the header information of the program data D_{P}.

As evident from (C) of FIG. 19, if ε₂<T_{LS}, the head reference position P_{ds} is located after the end position of the target program data D_{P}. Therefore, the digest reader 52 determines that the present unit section cannot be read, and then ends the process of FIG. 16.

As illustrated in (C) of FIG. 19, if ε₂≧T_{LS}, the head reference position P_{ds} precedes the end position of the target program data D_{P}. Therefore, the digest reader 52 determines that the unit section can be read, and then proceeds to step S613.

With the process of step S67 through S612, the digest reader 52 checks to see whether the unit section of the target program data D_{P} can be read. Next, the digest reader 52 determines the start and end positions of the unit section. For this determination, the digest reader 52 determines whether the program start mark M_{bs} is equal to or smaller than the head reference mark M_{ds} (step S613).

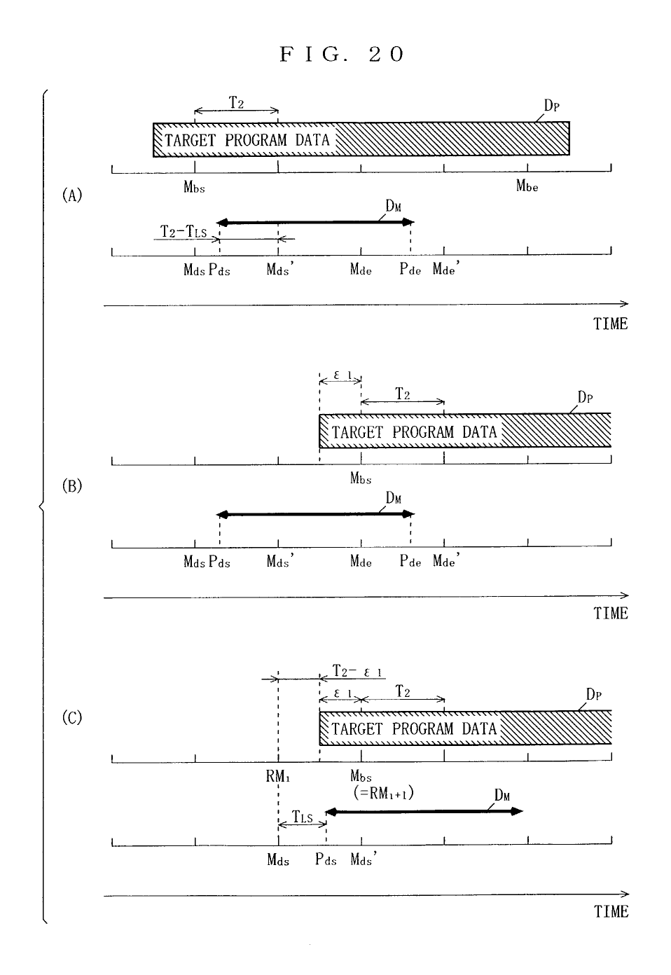

As illustrated in (A) of FIG. 20, if M_{bs}≦M_{ds}, the program start mark M_{bs} precedes the head reference mark M_{ds}. Therefore, the digest reader 52 sets the first possible reference mark M_{ds}′ as a digest start mark Mₛ, that is, the reference mark RMᵢ that defines the start position of the unit section of the digest (step S614).

The digest reader 52 then sets (T₂−T_{LS}) as a start time F of the program digest with reference to the digest start mark Mₛ (step S615).

Through steps S614 and S615, the start position of the unit section is determined so as to be located at a position (T₂−T_{LS}) behind in time from the first possible reference mark M_{ds}′.

As illustrated in (B) of FIG. 20, if M_{bs}>M_{ds}, the digest reader 52 determines whether the first possible reference mark M_{ds}′ is smaller than the program start mark M_{bs} (step S616).

As illustrated in (B) of FIG. 20, if M_{ds}′<M_{bs}, the program start mark M_{bs} is located at a position after the head reference position P_{ds}. Therefore, the digest reader 52 sets the program start mark M_{bs} as the digest start mark Mₛ (step S617) The digest reader 52 then sets the time ε₁ as the start time Fₛ of the program digest with reference to the digest start mark Mₛ (step S618). Through steps S617 and S618, the start position of the unit section is determined so as to be located at a position ε₁ behind in time from the program start mark M_{bs} on the target program data D_{P}.

As illustrated (C) of FIG. 20, if M_{ds′≧M}_{bs} in step S616, the start position and the head reference position P_{ds} of the target program data D_{P} are located between the two successive reference marks RMᵢ and RMᵢ₊₁. In this case, the digest reader 52 has to compare a time interval defined by either one of the reference marks RMᵢ and RMᵢ₊₁ and the head reference position P_{ds} and a time interval defined by either one of the reference marks RMᵢ and RMᵢ₊₁ and the start position of the program data D_{P}. Here, as described above, the head reference position P_{ds} can be represented as (RMᵢ+T_{LS}), and the start position of the program data D_{P} can be represented as (RMᵢ₊₁−ε1). Furthermore, since RMᵢ₊₁−RMᵢ=T₂ (constant value), the start position of the program data D_{P} can be represented as (RMᵢ+(T₂−ε₁)) Therefore, the digest reader 52 determines whether the time T_{LS} is equal to or larger than the time (T₂−ε₁) (step S619).

As illustrated in (C) of FIG. 20, if T_{LS}≧(T₂−ε₁) the start position of the program data D_{P} is located at the head reference position P_{ds} or precedes the head reference position P_{ds}. Therefore, the digest reader 52 performs the above-described steps S614 and S615. For this reason, the head reference mark M_{ds} is not set as the digest start mark Mₛ in step S614 and T_{LS} is not set as the start time Fₛ in step S615. More specifically, if T_{LS}≧(T₂−ε₁) in step S619, this means that the target program data D_{P} has not been provided with the reference mark RMᵢ corresponding to the head reference mark M_{ds}. As such, since there is no such reference mark RMᵢ, the digest reader 52 cannot read the target program data D_{P} from a position the time T_{LS} ahead in time from the head reference mark M_{ds}. For this reason, in steps S614 and S615, the first reference mark M_{ds}′ and the time (T₂−T_{LS}) are respectively set.

As evident from (C) of FIG. 20, if T_{LS}<(T₂−ε₁), the start position of the program data D_{P} is located at a position after the head reference position P_{ds}. Therefore, the digest reader 52 performs steps S617 and S618.

With steps S613 through S619, the digest reader 52 has determined the start position of the unit section. Now, the digest reader 52 determines the end position. Specifically, after either one of steps S615 and S618, the digest reader 52 determines whether the second reference mark M_{de} is smaller than the program end mark M_{be} (step S620).

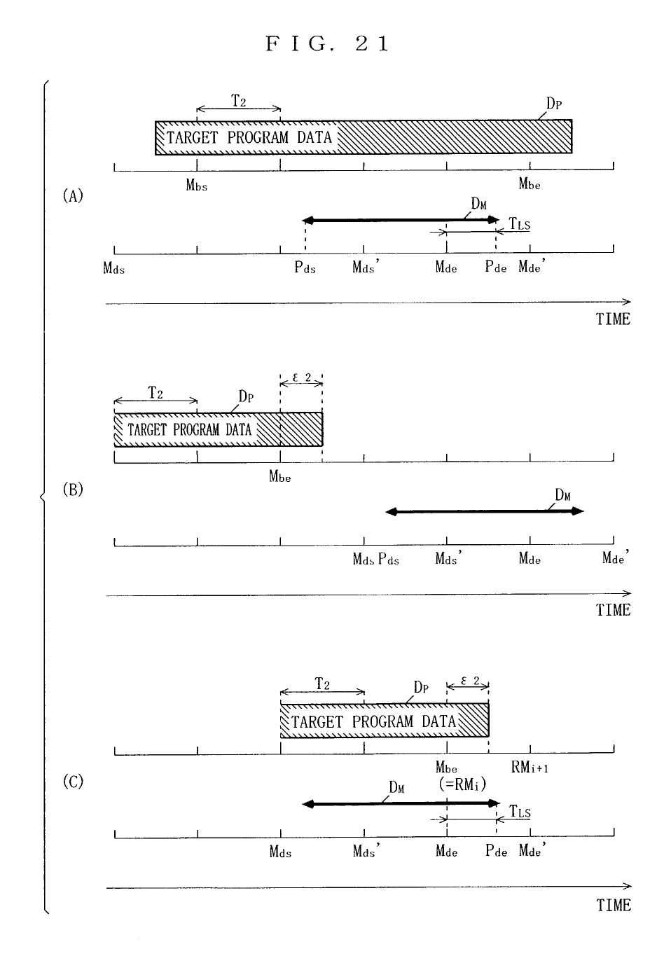

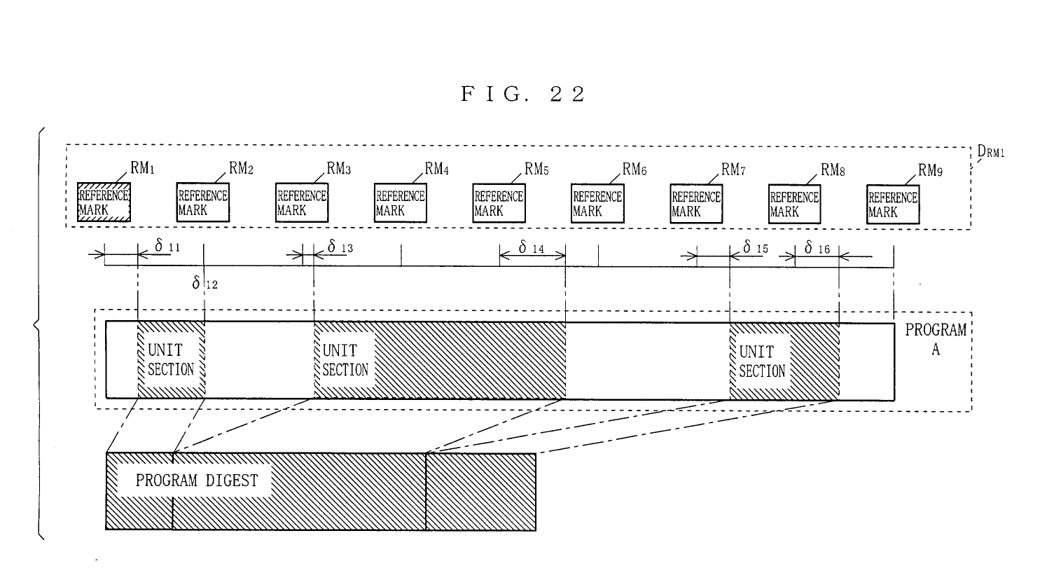

As illustrated in (A) of FIG. 21, if M_{de}<M_{be}, the program end mark M_{be} is located at a position after the end reference position P_{de}. Therefore, the digest reader 52 sets the reference mark M_{de} as a digest end mark Mₑ, that is, a reference mark RMᵢ defining the end position of the unit section (step S621).

The digest reader 52 then sets the elapsed time T_{LS} as an end time Fₑ of the program digest with reference to the digest end mark Mₑ (step S622)

In the above steps S621 and S622, the end position of the unit section is the end reference position P_{de}.

If M_{de}≧M_{be} in step S620, the digest reader 52 determines whether the second reference mark M_{de} is larger than the program end mark M_{be} (step S623).

As illustrated (B) of FIG. 21, if M_{de}>M_{be}, this means that the end reference position P_{de} is located behind the program end mark M_{be}. Therefore, the digest reader 52 sets the program end mark M_{be} as the digest end mark Mₑ (step S624).

The digest reader 52 then sets the time ε₂ as the end time Fₑ of the program digest with reference to the digest end mark Mₑ (step S625).

In steps S624 and S625, the end position of the unit section is the end position of the program data D_{P}, that is, a position the time ε₂ ahead from the program end mark M_{be}.

If M_{de}≦M_{be} in step S623, as illustrated in (C) of FIG. 21, the end reference position P_{de} and the end position of the program data D_{P} are located between two successive reference marks RMᵢ and RMᵢ₊₁. In this case, the digest reader 52 has to compare a time interval defined by either one of the reference marks RMᵢ and RMᵢ₊₁ and the end reference position P_{de} and a time interval defined by defined by either one of the reference marks RMᵢ and RMᵢ₊₁ and the end position of the program data D_{P}. Here, the program data D_{P} can be represented as (RMᵢ+T_{LS}), and the end position of the program data D_{P} can be represented as (RMᵢ+ε₂). Therefore, if M_{de}≦M_{be} in step S623, the digest reader 52 determines whether the time T_{LS} is equal to or larger than the time ε₂ (step S626).

As illustrated (C) of FIG. 21, if T_{LS}≧ε₂, the digest reader 52 regards that the end position of the program data D_{P} is located at a position after the end reference position P_{de}. Therefore, the digest reader 52 performs steps S621 and S623.

As evident from (C) of FIG. 21, if T_{LS}<ε₂ the end reference position P_{de} is behind the end position of the program data D_{P}. Therefore, the digest reader 52 performs steps S624 and S625.

With the above steps S620 through S626, the digest reader 52 has determined the end position of the unit section. Next, the digest reader 52 reads the unit section. More specifically, after either one of steps S623 and S625, the digest reader 52 sets the digest start mark Mₛ as the current position mark M_{c} that has been described in the above embodiment (step S627).

The digest reader 52 then reads, out of the program data D_{P}, a portion defined by the read start time Fₛ with reference to the digest start mark Mₛ and the reference mark RMᵢ subsequent to the current digest mark Mₛ, from the recording medium 25. The read portion is taken as the digest data D_{D}. The digest reader 52 then sends the read digest data DD to the AV decoder 28 (step S628). As a result, the display 29 and the loudspeaker 210 output video and audio according to the video data D_{DV} and the audio data D_{DA} reproduced by the AV decoder 28. That is, what is reproduced by the reception apparatus 5 is a first unit section.

The digest reader 52 then determines whether the current position mark M_{c} exceeds the current digest mark Mₑ (step S629).

If Mₑ≧M_{c}, the digest reader 52 determines whether a reference mark RMᵢ that is located immediately subsequent to the current position mark M_{c} and is not the digest end mark Mₑ (such a reference mark hereinafter referred to as a next mark M_{c+1}) is included in the target program data D_{P} (step S630).

If it is determined in step S630 that such a next mark M_{C+1} is included, the digest reader 52 reads, out of the program data D_{P}, a portion defined by the current position mark M_{c} and the next mark M_{c+1} the program data D_{P} from the recording medium 25, and sends the read portion to the AV decoder 28 (step S631). As a result, the display 29 and the loudspeaker 210 output video and audio according to the video data D_{DV} and the audio data D_{DA} reproduced by the AV decoder 28. That is, what is reproduced by the reception apparatus 5 is an intermediate unit section. Next, the digest reader 212 sets the next mark M_{c+1} as the current position mark M_{c} (step S632), and then proceeds to step S629.

If Mₑ<M_{c} instep S629 or if it is determined in step S630 that no next mark M_{c+1} is included, the digest reader 52 reads, out of the program data D_{P}, a portion defined by the current position mark M_{c} and the read end position Fₑ with reference to the current digest end mark Mₑ, from the recording medium 25. The read portion is taken as the digest data D_{D}. The digest reader 52 then sends the digest data DD to the AV decoder 28 (step S633). That is, what is reproduced by the reception apparatus 5 is a last unit section.

With the above steps S627 through S633, the digest reader 52 reads the program data D_{P} from the recording medium 25 so as to read the unit sections composing the digest. Then, after the step S633, the digest reader 52 exits the process of FIG. 17, and then returns to step S51 of FIG. 15.

An exemplary program digest resulted from the above processes is described below with reference to FIG. 22. Now, assume herein that the user desires to view a digest of program A illustrated in FIG. 3, and selects the digest mark data D_{M1}. Under this assumption, after the processes of FIGS. 15 through 17, what is played first in program A is a portion defined by a position located at the time δ₁₁ ahead of the reference mark RM₁, and the reference mark RM₂. The reception apparatus 5 outputs video and audio corresponding to that portion (diagonally-shaded in FIG. 22) as the program digest. Then, what is played next is a portion defined by a position located at the time δ₁₃ ahead of the reference mark RM₃ and a position located at the time δ₁₄ ahead of the reference mark RM₅. The reception apparatus 5 outputs video and audio corresponding to that portion (diagonally-shaded in FIG. 22) as the program digest. Then, what is played last is a portion defined by position located at the time δ₁₅ ahead of the reference mark RM₇ and a position located at the time δ₁₆ ahead of the reference mark RM₈. The reception apparatus 5 outputs video and audio corresponding to that portion (diagonally-shaded in FIG. 22) as the program digest.

As has been described in the foregoing, according to the modification example, in addition to the effects achieved by the above embodiment, the reception apparatus 5 generates the digest mark data D_{M} from the reference mark RMⱼ and the elapsed time T_{LS} held at the time of the user's operation of the input unit 26 (refer to steps S13, S42, and S43). With this, compared with the above embodiment, it is possible to generate the digest mark data D_{M} more accurately reflecting the time of the user's operation. This generation scheme is especially effective in a case where the time interval T₂ is sufficiently short. This is because, in such a case, the time of the user's operation can be approximate to the time indicated by the reference mark RMⱼ.

While the invention has been described in detail, the foregoing description is in all aspects illustrative and not restrictive. It is understood that numerous other modifications and variations can be devised without departing from the scope of the invention.

What is claimed is:

1. A stream generation apparatus, comprising:
an encoding section operable to encode video data composing a program;
a clock generating section operable to generate a clock signal at a first time interval;
a timing signal generating section operable to generate a timing signal from the clock signal received from the clock generating section for output at a second time interval; and
a reference mark adding section operable to add, in accordance with the timing signal generated by the timing signal generating section, reference mark data composed of a reference mark for use in generation of a program digest to the video data encoded by the encoding section.

2. The stream generation apparatus according to claim 1, wherein
the reference mark adding section adds, in accordance with the timing signal generated by the timing signal generating section, the reference mark data to the video data encoded by the encoding section at the first time interval.

3. A digest mark data generation apparatus, comprising
a recording medium that records program data representing a predetermined program, the program data including video data and audio data, and the video data added with reference mark data composed of one or more reference marks added at a predetermined time interval;
an input section operable to generate, in response to an operation by a user, timing designation data indicative of a start or an end of a program digest;
a mark data generating section operable to select, in accordance with timing designation data generated by the input section, a reference mark from the reference marks added to the video data recorded on the recording medium, and to generate digest mark data including the selected reference mark; and
a recording section operable to record the digest mark data generated by the mark data generating section on the recording medium.

4. The digest mark data generation apparatus according to claim 3, further comprising:
a mark data reading section operable to read the digest mark data recorded on the recording medium; and
a communications section operable to transmit the digest mark data read by the mark data reading section to another apparatus via a communications network.

5. The digest mark data generation apparatus according to claim 3, wherein
the mark data generating section selects the reference mark added to the video data recorded on the recording medium, and generates the digest mark data including a set of data composing the selected reference mark and an elapsed time from a time of selecting the reference mark until a time of receiving the timing designation data from the input section.

6. The digest mark data generation apparatus according to claim 3, further comprising
a digest reading section
operable to set a head reference mark and a second reference mark from out of the reference marks included in the digest mark data recorded on the recording medium,
operable to set a first reference mark and a last reference mark of the program data recorded on the recording medium as a program start mark and a program end mark, and
operable to read, out of the program data recorded on the recording medium, a portion defined by either one of the head reference mark and the program start mark and either one of the second reference mark and the program end mark, when the second reference mark is located after the program start mark and the head reference mark is located before the program end mark.

7. The digest mark data generation apparatus according to claim 3, further comprising
a digest reading section
operable to set a first reference mark and a last reference mark of the program data recorded on the recording medium as a program start mark and a program end mark,
operable to set a head reference mark and a second reference mark from out of the reference marks included in the digest mark data recorded on the recording medium,
operable to set, from out of the reference marks of the program data recorded on the recording medium, a reference mark located immediately after a reference mark corresponding to the head reference mark as a first possible reference mark, and a reference mark located immediately after a reference mark corresponding to the second reference mark as a second possible reference mark, and
operable to read, as digest data, from the program data recorded on the recording medium, a portion defined by either one of a position located at a first time period before a time indicated by a program start mark of the program data and a position located at a second time period before a time indicated by the first possible reference mark; and either one of a position located at a third time period before a time indicated by a program end mark of the program data and a position located at a fourth time period after a time indicated by the second reference mark.

8. A method of generating a stream, comprising the steps of:
encoding video data constructing a program;
generating a clock signal at a first time interval;
generating a timing signal at a second time interval from the clock signal generated in the clock signal generating step; and
adding reference mark data composed of a reference mark for use in generation of a program digest to the video data encoded by the encoding step in accordance with the timing signal generated in the timing signal generating step.

9. A method of generating digest mark data, comprising the steps of:
reading program data recorded on a recording medium, the program data including the video data and audio data, and the video data added with reference mark data composed of one or more reference marks added at a predetermined time interval; and
receiving timing designation data indicative of a start or an end of a program digest, selecting a reference mark from the reference marks added to the video data read in the reading step in accordance with the received timing designation data, and generating the digest mark data that includes the selected reference mark.
